(19) United States
(12) Patent Application Publication
(10) Pub. No.: US 2009/0195807 A1
(43) Pub. Date: Aug. 6, 2009

(54) IMAGE PROCESSING APPARATUS AND IMAGE PROCESSING METHOD

(75) Inventors: Taku SONEOKA, Kyoto-shi (JP); Hisanori TOMITA, Kyoto-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Murata Machinery, Ltd., Kyoto-shi (JP)

(21) Appl. No.: 12/354,325

(22) Filed: Jan. 15, 2009

(30) Foreign Application Priority Data
Feb. 6, 2008 (JP) 2008-026146

(51) Int. Cl. G06F 3/12

(52) U.S. Cl. 358/1.13; 358/1.15

(57) ABSTRACT

An image processing apparatus includes a scanner and a printer, transmits an image data and a metadata in which an attribute of the image data is described to a document management server, and further includes an output control unit arranged to control whether to output both the image data and the metadata or to output only the metadata.

### CROSS-REFERENCE TO RELATED APPLICATIONS

This application claims priority under 35 U.S.C. 119 to Japanese Patent Application No. 2008-026146, filed on Feb. 6, 2008, the entire contents of which are incorporated herein by reference.

### BACKGROUND

1. Field

The present invention relates to an image processing apparatus such as a scanner, a printer, and a facsimile machine.

2. Description of the Related Art

In a Multi Function Peripheral (MFP) including a scanner, a printer, and further a facsimile processing unit, it is commonly known that a scanned image, a copied image, and an image that is transmitted/received via facsimile are stored along with metadata in a document management server. The contents of processes performed through the MFP and/or attribute of the processed images are described in the metadata. Attribute etc. of image data is described in the metadata, which is described in a file format such as an Extensible Markup Language (XML). A system that makes it possible to manage documents in the document management server is referred to as a Document Management System (DMS). The DMS includes a database in which the metadata is stored and a database in which the image data is stored. Through the use of the DMS, the metadata can be searched, and the corresponding image data can be output. Therefore, the efficient use of the image data processed in the MFP etc. can be easily achieved. However, when both the image data and the metadata are stored in the document management server, a substantial amount of memory is used.

### SUMMARY

In order to overcome the problems described above, embodiments of the present invention enable management of usage status of an image processing apparatus while saving a memory of a document management server. Moreover, according to the embodiments of the present invention, whether to output both image data and metadata together or to output only the metadata can be easily controlled. Further, according to the embodiments of the present invention, a charge for copying can be reliably made.

According to an embodiment of the present invention, an image processing apparatus includes a scanner and a printer, and transmits image data and metadata in which attribute of the image data is described to a document management server. Further, the image processing apparatus includes an output control unit that controls whether to output both the image data and the metadata together or to output only the metadata.

According to an embodiment of the present invention, the image processing apparatus further includes a storage unit arranged to store a plurality of templates of the metadata, and the output control unit performs the control in accordance with a type of the template. Furthermore, a switch is preferably provided for a user to select whether or not to output only the metadata.

An embodiment of the present invention provides a program of the image processing apparatus that includes the scanner and the printer, and that transmits the image data and the metadata in which the attribute of the image data is described to the document management server. Further, the embodiment provides an output control instruction that is executed in order to control whether to output both the image data and the metadata together or to output only the metadata.

According to an embodiment of the present invention, whether to output both the image data and the metadata together to the document management server or to output only the metadata to the document management server can be controlled. Accordingly, when storing important documents such as contracts, the corresponding image data and metadata can be stored, and when storing miscellaneous materials, only the corresponding metadata can be stored. Moreover, when the image data cannot be stored for security reasons, the corresponding metadata can be stored. As a result, a memory of the document management server can be saved. The metadata is stored in either case, and thus, the usage status of the image processing apparatus can be managed.

Further, when the plurality of templates of the metadata is stored in the image processing apparatus, it can be determined whether to output both the image data and the metadata together or to output only the metadata in association with the template. The user can easily select to output only the metadata. Furthermore, by including at least information that is used to specify the user and the number of printouts in the metadata for a copying process, each user can be appropriately and reliably charged.

Other features, elements, processes, steps, characteristics and advantages of the present invention will become more apparent from the following detailed description of embodiments of the present invention with reference to the attached drawings.

### BRIEF DESCRIPTION OF THE DRAWINGS

FIG. 1 is a block diagram illustrating an MFP and its usage environment according to an embodiment of the present invention.

FIG. 2 illustrates a template of metadata according to an embodiment of the present invention.

FIG. 3 illustrates an example of metadata described in an XML format according to an embodiment of the present invention.

FIG. 4 illustrates an example of metadata described in a Comma Separated Value (CSV) format according to an embodiment of the present invention.

FIG. 5 is a flowchart illustrating a process in which a metadata file is created through a process in which the file is stored in a DMS server according to an embodiment of the present invention.

FIG. 6 illustrates an example of outputting a metadata file according to an embodiment of the present invention.

FIG. 7 illustrates an output algorithm of a metadata file according to an embodiment of the present invention.

FIG. 8 is a block diagram of a metadata management program according to an embodiment of the present invention.

### DETAILED DESCRIPTION OF PREFERRED EMBODIMENTS

Embodiments of the present invention will be described below.

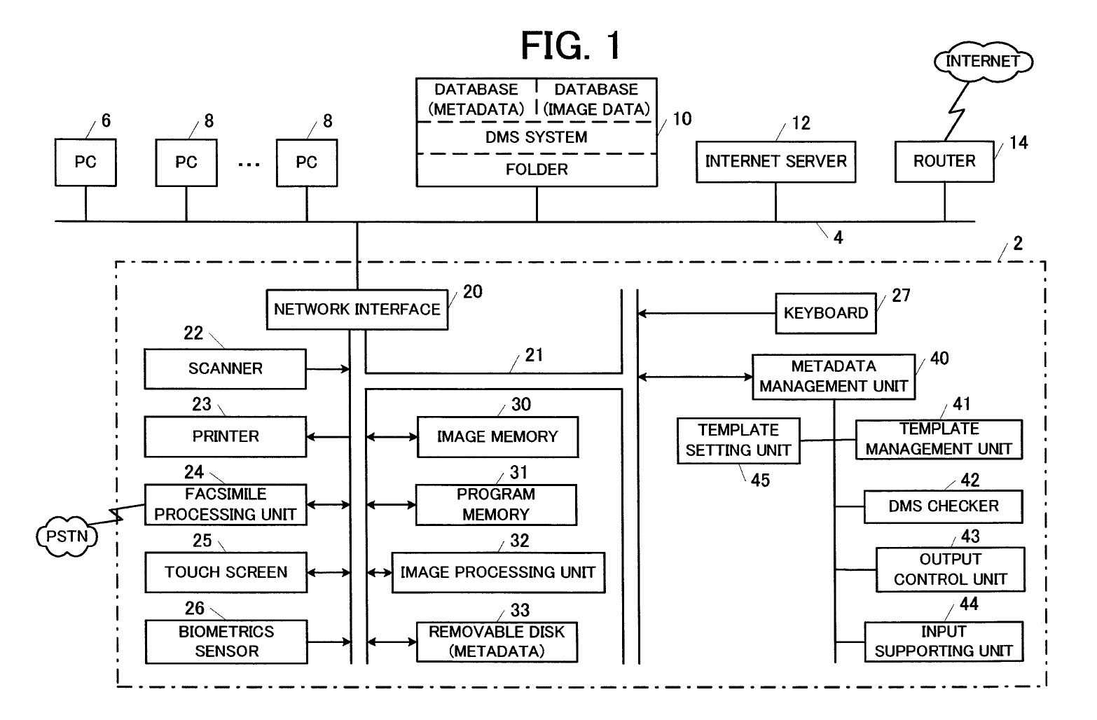

FIGS. 1 through 8 illustrate an MFP 2 and a metadata management program 86 according to an embodiment of the present invention. In FIG. 1, reference numeral 4 denotes a Local Area Network (LAN), 6 denotes an administrator terminal, 8 denotes a user terminal, which is normally provided in plural, and 10 denotes a DMS server. A Personal Computer (PC) is commonly used as the administrator terminal 6 and the user terminal 8, and also as the DMS server 10. Such a PC includes a folder arranged to temporarily store data to be output/input, a database arranged to manage metadata, and a database arranged to store image data that is linked to the metadata, i.e., image data that is associated with the metadata. The DMS server 10 is arranged to store a DMS main body including the metadata database, the image data database, folders, and software arranged to manage the input and output of both the metadata and the image data.

Reference numeral 12 denotes an Internet server, which includes, for example, Internet application servers such as a Simple Mail Transfer Protocol (SMTP) server and a Post Office Protocol (POP) server. The Internet and the LAN 4 are connected with each other via a router 14. The MFP 2 is connected with the LAN 4 via a network interface 20, and transmits/receives Internet facsimile to/from the Internet via the Internet server 12. The network interface 20 is connected with a bus 21.

Reference numeral 22 denotes a scanner, which may be a color scanner or a monochrome scanner. Reference numeral 23 denotes a printer, which may be a color printer or a monochrome printer. Reference numeral 24 denotes a facsimile processing unit, which is arranged to transmit/receive Internet facsimile via the SMTP server etc. of the Internet server 12, and/or to transmit/receive Group 3 (G3) facsimile via a Public Switched Telephone Network (PSTN). The facsimile processing unit 24 may be omitted. A user is provided through the MFP 2 with services such as scanning of image data and copying of image data. In addition, such services include printing of image data that is transmitted from the user terminal 8 etc., facsimile transmission and facsimile reception.

The MFP 2 includes, as a user interface, a touch screen 25, a biometrics sensor 26, and a keyboard 27. The touch screen 25 includes a plurality of pressure-sensitive switches on a display panel for input. The biometrics sensor 26 may be a fingerprint sensor and a vein sensor, for example, and is used to authenticate the user operating the MFP 2. The keyboard 27 includes input switches other than the touch screen 25. The biometrics sensor 26 and the keyboard 27 may be omitted.

An image memory 30 is arranged to store the image data. A program memory 31 is arranged to store programs that are used to control the MFP 2, and in particular, store the metadata management program 86 to be described later. An image processing unit 32 performs image processing such as image reduction, image enlargement, image sharpening, and background color removal. The image processing here defines a process of creating new image data by processing the image data. A removable disk 33 is arranged to store the metadata or the like, and can be removably provided to the MFP 2. The image memory 30 and the program memory 31 may be replaced with a hard disk, a Random Access Memory (RAM), or a removable disk.

A metadata management unit 40 is arranged to manage the metadata created in the MFP 2. Attribute of a scanned image, copied image, printed image, and transmitted/received image is described in the metadata. The metadata is output as a metadata file to the DMS server 10 along with an image data file. The metadata is stored in the metadata database, and the image data is stored in the image data database. The user searches the metadata database by using the terminals 6, 8, or the touch screen 25, and thus can access desired image data. The metadata functions as a conventional log file, and records who used the MFP 2, and when and how the MFP 2 was used, for example. More specifically, the contents of processes such as a scanning process and a printing process, a name of the user who operated the MFP 2, date and time of the process, and the number of pages of the processed images, for example, are stored in system data of the metadata.

The contents of the image and other key words are described as user items. By searching the DMS server 10, the usage status of the MFP 2 with respect to each user can be acquired, for example, and thus, charge data can be created. In accordance with the record about which data has been processed or about who processed the data, or the like, image data security can be improved. For example, by creating the metadata and storing the metadata in the DMS server 10 each time the image data is scanned or copied, illegal copying or external use of the image data can be restricted. By using the metadata, in particular, by using user data, the images can be searched. In the present embodiment, the metadata is stored in different formats with respect to each type of the image data, such as a purchase order, an invoice, and a contract, for example. Accordingly, the image data is categorized to be stored in the DMS server 10. Therefore, by searching the DMS server 10, necessary image data can be accessed.

In the present embodiment, a template and the format mean the same (i.e., they are synonyms). A form of the metadata file and data items are specified in the template, and a plurality of metadata templates are normally stored. A template management unit 41 is arranged to store the templates in the removable disk 33, display the templates at the terminals 6, 8 or on the touch screen 25 so as to enable the user to input, and link the templates with the image data that is processed in the scanner 22, the printer 23, and the facsimile processing unit 24, so as to create the metadata file.

A DMS checker 42 is arranged to check whether or not the metadata file can be temporarily written in a folder of the DMS server 10 before the execution of the process performed in the scanner 22, the printer 23, or the facsimile processing unit 24. In other words, the DMS checker 42 is arranged to check whether or not the metadata can be stored before the execution of the image processing. If the metadata cannot be stored, the scanning process, the printing process, or the facsimile transmission, or the like, are paused, or the metadata is stored in the removable disk 33. An output control unit 43 is arranged to output an image file that corresponds to the metadata file to the DMS server 10 or the terminals 6, 8. In accordance with the settings with respect to each template, whether to output both the metadata file and the image file together or to output only the metadata can be selected. The output control unit 43 is arranged to control whether to output both the metadata file and the image data together or to output only the metadata.

An input supporting unit 44 is arranged to support the user to input the user data items through the touch screen 25 and the keyboard 27, or the like. For example, when improper data is input to the user item, the input supporting unit 44 checks such input, and guides the user to input in a proper data format. A template setting unit 45 is arranged to support a process of setting the template through the terminal 6, 8, or the touch screen 25.

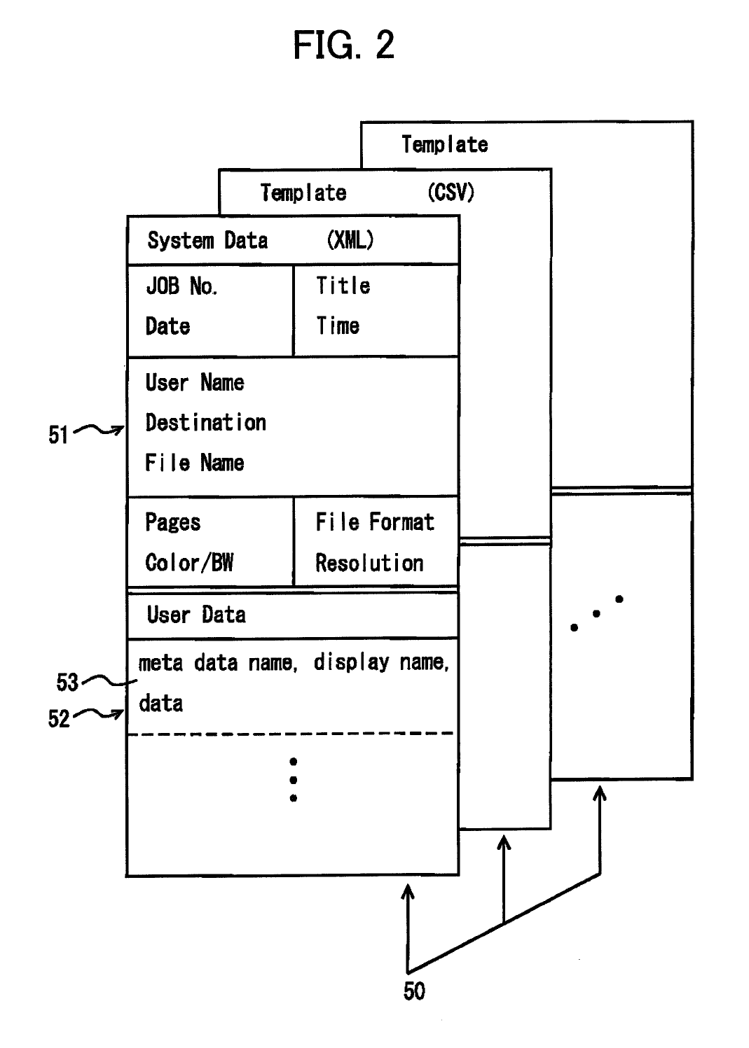

FIG. 2 illustrates an example of the template. Reference numeral 50 denotes an individual template, which can be described in a data format such as the XML and CSV in accordance with a type of the DMS server 10, and is separated into a system data area 51 and a user data area 52. Each data item in the system data area 51 is necessary for the DMS server 10. A user data item 53 in the user data area 52 is arbitrarily set at the time of setting through the terminals 6, 8, or the like. Two item names, i.e., an item name (metadata name) that is output as the metadata, and a data name (display name) that is displayed on the touch screen 25, etc., are stored in the user data item 53. Moreover, data that corresponds to the item name is also stored. A format of the data is fixed in accordance with the DMS server 10, and may include, for example, only numeric characters, alphanumeric characters, only alphabets, and alphabets and codes (symbols), or the like. A plurality of types of templates 50 are stored in the removable disk 33, and managed through the template management unit 41.

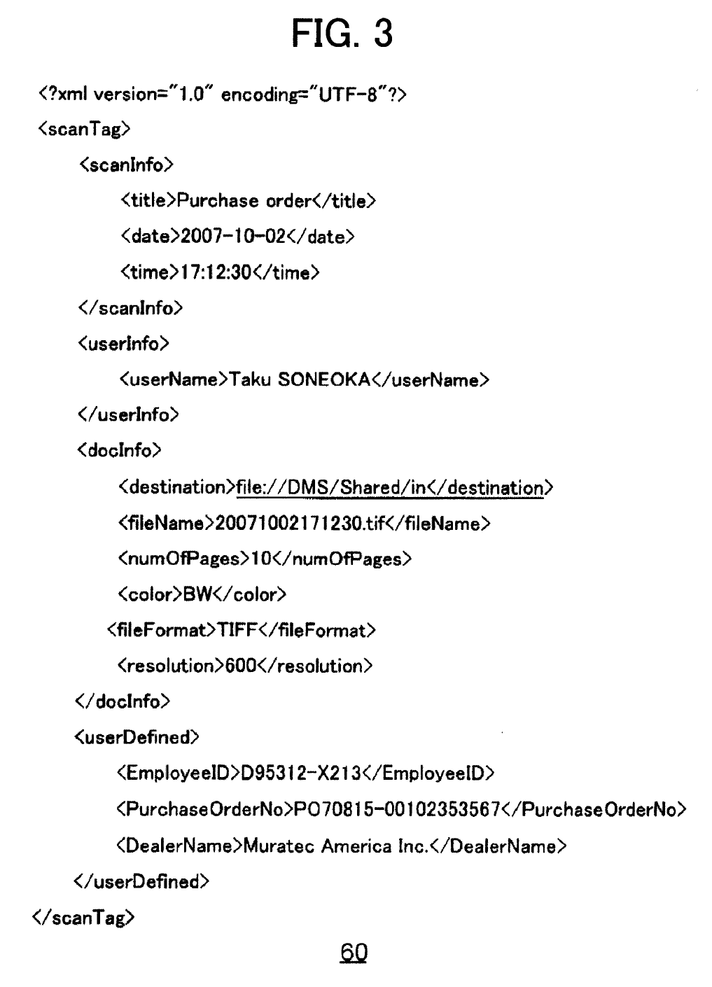

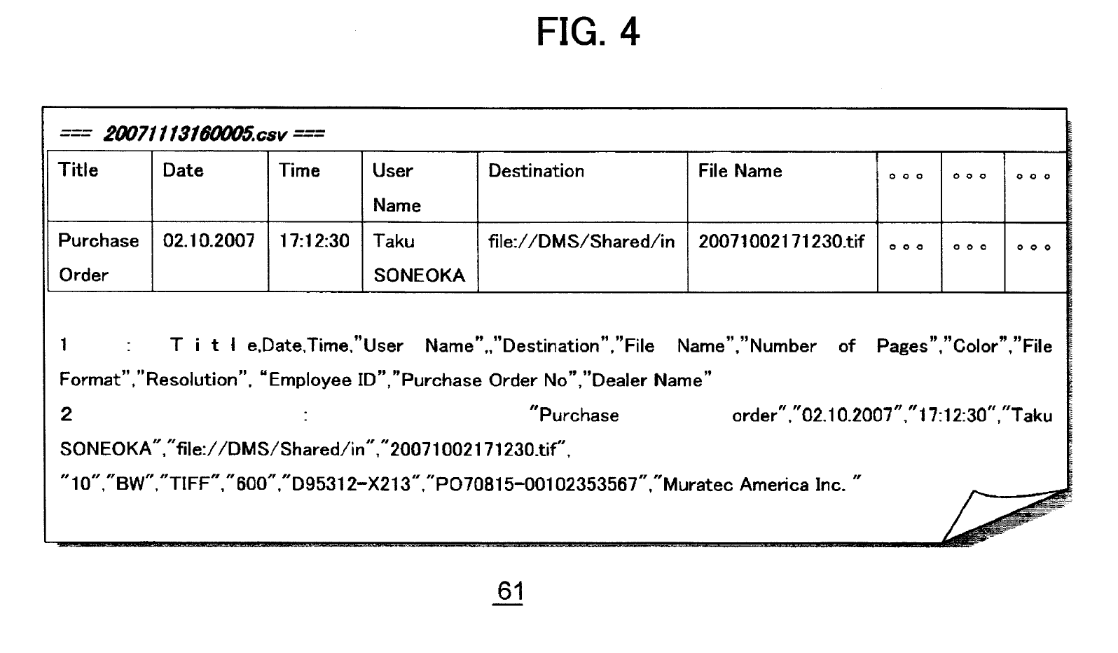

FIGS. 3 and 4 illustrate metadata files 60 and 61, respectively, as an example. The metadata file 60 of FIG. 3 is described in an XML format. An area from the item “scanInfo” to the item “docInfo” in the first portion of the file corresponds to the system data area, and an area of the item “userDefined” corresponds to the user data area. The title “Purchase order” in the system data indicates a type of the image data, and also a type of the format. The date on which the scanning was performed, and a name of the user that performed the scanning, are also described. Further, a storage destination of the metadata, a storage destination of the corresponding image data, a file name used in the DMS server 10, the number of pages, a type indicating monochrome or color, a file format of the image data, and a resolution, or the like, are also described. These items are necessary for the DMS server 10, and therefore, if the DMS server 10 cannot detect the data regarding these items from the metadata file, the DMS server 10 cannot manage the metadata and the image data. Accordingly, the system data and the user data are separated in the file based on respective positions thereof, and it is arranged such that the DMS server 10 can detect the necessary data items first by checking the metadata file from top to bottom. Among the data items, the items other than the title and the user name can be automatically set on a side of the MFP 2. For example, the date, the destination, the file name, the number of pages, the file format, and the resolution, etc., can be automatically set on the side of the MFP 2. The user name and the type indicating monochrome or color may be obtained through the user's input operation on the touch screen 25.

In the metadata file 61 of FIG. 4, substantially the same data as the data of the metadata file 60 of FIG. 3 is described in a CSV format. Different data formats are required because the data format is set with respect to each DMS server, and in order to deal with a plurality of DMS servers, a plurality of template formats is required.

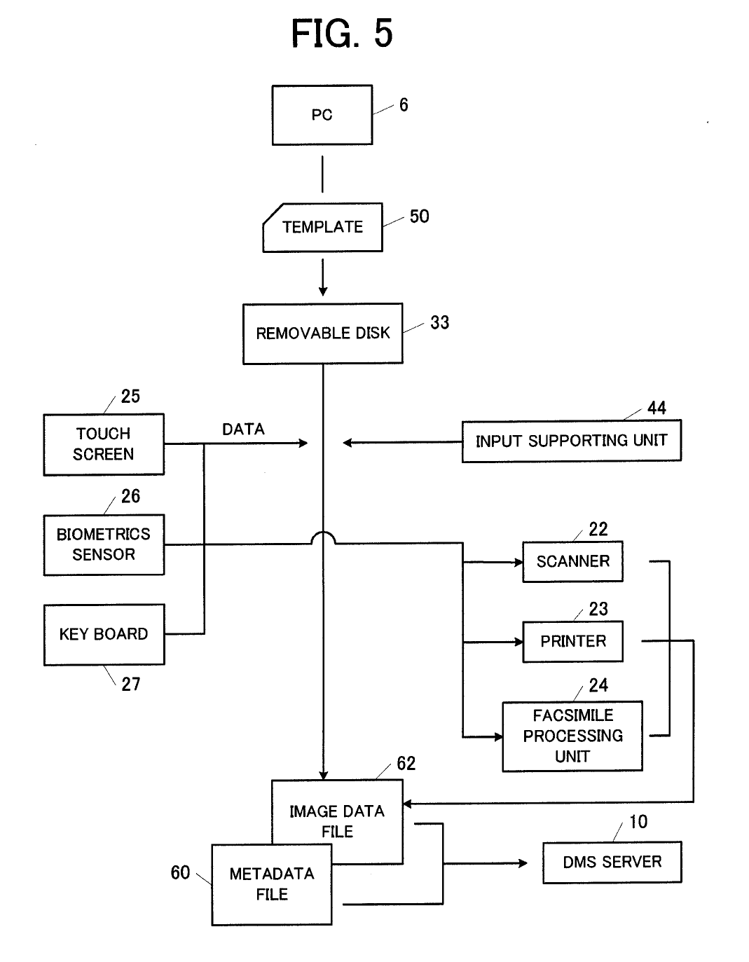

FIG. 5 illustrates a process of creating a template through a process of transmitting the metadata file 60 to the DMS server 10 according to an embodiment of the present invention. The settings for the template 50 are performed through the administrator terminal 6 or the user terminal 8. The template setting unit 45 of the MFP 2 supports the settings by providing a setting screen, or the like. The set template is stored in the removable disk 33. The user operating the MFP 2 inputs data into the template through the touch screen 25 and the keyboard 27, etc. The user name may be input through the touch screen 25, or after the user is authenticated through the biometrics sensor 26, a user name of the authenticated user may be input into the template.

At this time, the input supporting unit 44 supports to facilitate the user's input operation. For example, when an alphabet is input into a data item in which only the input of the numeric characters are permitted, the input supporting unit 44 detects an error, and displays a portion of the error. Moreover, the input supporting unit 44 is arranged to blur some of the input switches displayed on the touch screen so that the blurred switches cannot be used with respect to the item into which data is currently being input, thereby preventing erroneous input. Further, when a digit number of the data is specified in advance, unless the data of the prescribed digit number is input, the input supporting unit 44 displays an error indicating that the data is insufficient or that the data exceeds in length. Thus, with the help of the input supporting unit 44, proper data can be input. Data is required in all of the data items in the system data. Accordingly, unless the data that requires to be input by the user is input, the input supporting unit 44 displays the error. On the other hand, in the user data, it can be arranged such that the data may not be input into some of the items, or such that the data should be input into all of the items.

When performing the copying process, the printing process, and the facsimile transmission, it is required to complete the input of the metadata before the execution of such processes. When performing the scanning process, an order of the input of the metadata and the execution of the scanning process may be properly determined. The scanned, printed or copied image data and the image data transmitted/received via facsimile will be referred to as an image data file 62. The metadata file 60 is created from the input metadata. The image data file 62 and the metadata file 60 are linked with each other, and are transmitted to the DMS server 10, for example.

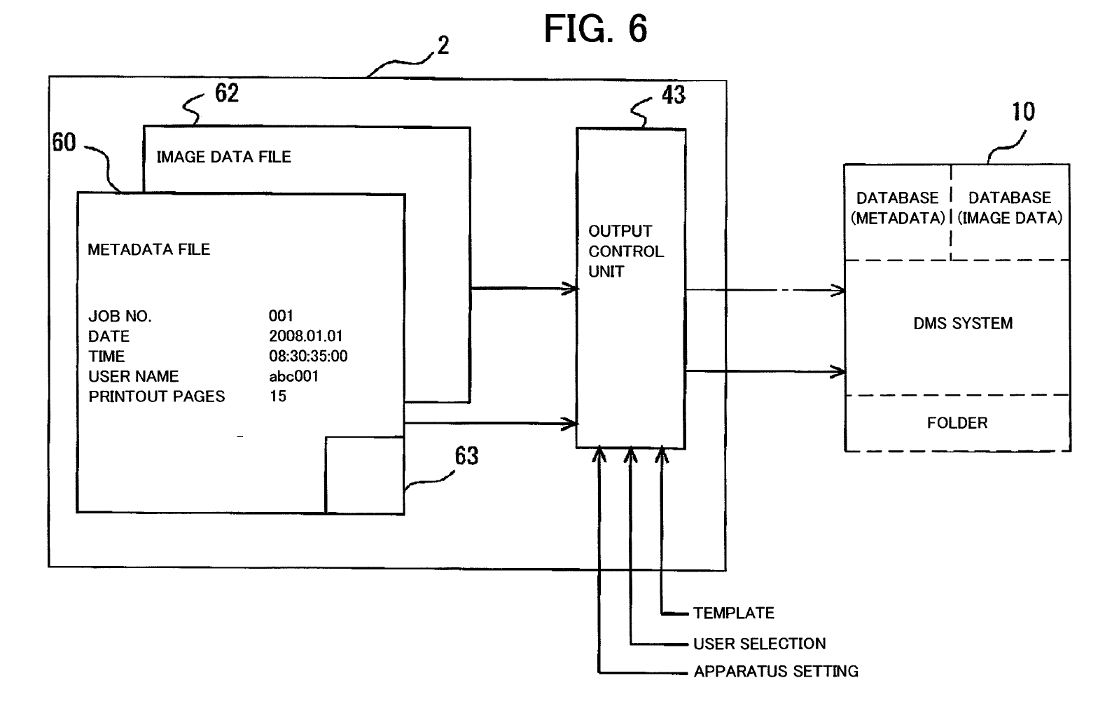

With reference to FIG. 6, a case where only the metadata file 60 is transmitted from the MFP 2 to the DMS server 10 will be described. When the image data is read through the copying process of the MFP 2, the image data file 62 and the metadata file 60 in the XML format that is linked with the image data file 62 are created. The date of the process, the user name, and the number of printouts, or the like, are described in the metadata file 60 as the data items that are necessary for the copying process. The output control unit 43 controls whether to output both the metadata file 60 and the image data file 62 to the DMS server 10 or to output only the metadata file 60 to the DMS server 10. In the present embodiment, a full (solid) line indicates that only the metadata file 60 is output.

The data items necessary for the copying process that are described in the metadata file 60 are determined based on the template stored in the removable disk 33 of FIG. 1. The template is prepared with respect to each process such as the copying process and the scanning process, and with respect to each type of documents such as a contract and an invoice. The data items that are specific to each process are described in the template. A thumbnail image 63 of the image data may be displayed in the metadata to provide the user with rough image data. The thumbnail image does not become a problem in view of security.

The output control can be performed by determining, with respect to each template used in the processes, whether to output the metadata file along with the image data file or to output only the metadata file. For example, when copying an important document such as a contract and an invoice, for example, the user selects a template that is used to copy the important document, and outputs the corresponding metadata file along with the image data file to the DMS server 10 or to the terminals 6, 8, or the like. When copying a miscellaneous material, the user selects a template that is used to copy the miscellaneous material, and outputs only the corresponding metadata file to the DMS server 10.

The output control unit 43 is arranged to control whether to output the metadata file along with the image data file or to output only the metadata file in accordance with the template settings. Further, by setting in advance in the apparatus to output only the metadata with respect to each process, only the metadata file can be output in the copying process, for example. A switch that allows the user to select whether or not to output only the metadata file may be provided on the touch screen 25, or the like.

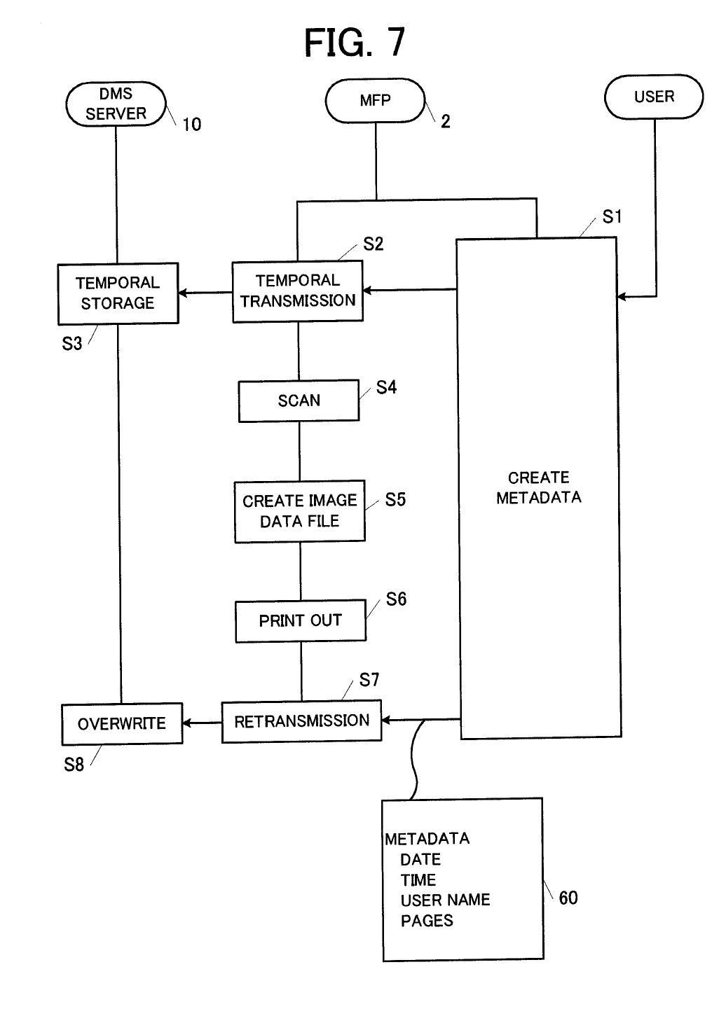

FIG. 7 illustrates an output algorithm of the metadata file. For example, when copying is instructed, the metadata file is created in parallel with the execution of the copying. Moreover, the system data such as the name of the operating user, the date of the process, and the number of printed-out images at the end of copying, is described (S1). The DMS checker 42 of the MFP 2 checks, before the execution of the copying, whether or not the metadata file can be temporarily written in a folder of the DMS server 10 (S2, S3). When the metadata file cannot be stored, the scanning or printing process is paused, or the metadata is stored in the removable disk 33, or the like. When the metadata can be temporarily written in the folder of the DMS server 10, image data is scanned (S4), and an image data file is created (S5). Then, the scanned image is printed out (S6), and the number of printed out images are written in the metadata file.

In the present embodiment, the date of the process, the user name, and the number of printouts of the metadata items are described, and the metadata file 60 is output (S7), and overwritten with respect to the temporal folder of the DMS server 10 (S8). The metadata file is stored in the DMS server 10. Thus, an administrator can reliably charge each user for the copying. Moreover, a processing history (record) of each user is also administered on a side of the DMS server 10. By describing in the metadata file a transmission target document and an address of a transmission destination, or the like, that are used in facsimile transmission, security management of documents can be performed.

Although not illustrated, if the copying process is paused, the number of printouts at the time of pausing is described in the metadata file and output. Therefore, a process of charging the user can be performed even if the copying is paused.

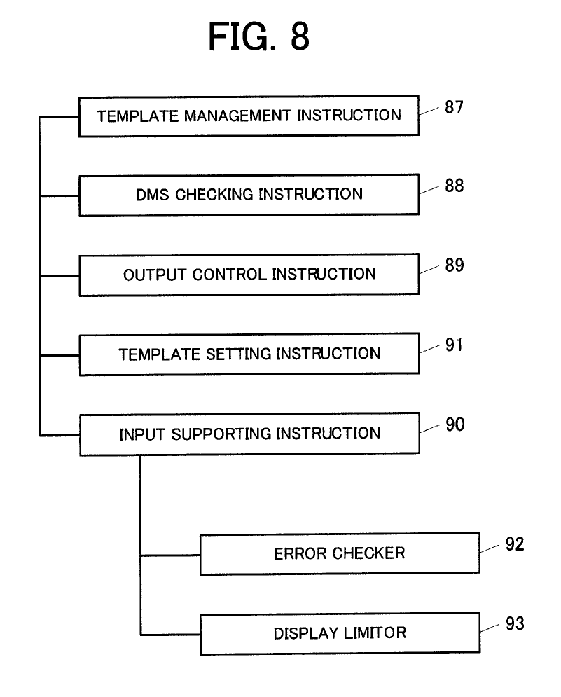

FIG. 8 illustrates the metadata management program 86. The metadata management program 86 is stored in the program memory 31 of FIG. 1, and supplied to a recording medium such as a Compact Disk Read Only Memory (CD-ROM) or to the MFP 2 through a carrier wave. Then, the metadata management program 86 is processed through the metadata management unit 40. When a template management instruction 87 is executed, general management of templates is performed. When a DMS checking instruction 88 is executed, whether or not the metadata file can be temporarily stored in the DMS server 10 is checked. When an output control instruction 89 is executed, whether to output only the metadata file to the DMS server 10 or to output the metadata file along with the image data file is controlled. When an input supporting instruction 90 is executed, the user's input to the template, in particular, the input into the user items is supported, erroneous (inappropriate) input data is checked, such checking is displayed, and unnecessary keys are hidden, for example, thereby the user is supported such that the user will not input data in an erroneous format. The settings for the templates performed in the terminal 6, or the like, are supported when a template setting instruction 91 is executed. The contents of the instructions 87 through 91 are used to achieve the above-described processes performed in the template management unit 41, the DMS checker 42, the output control unit 43, the input supporting unit 44, and the template setting unit 45. In the present embodiment, the description regarding the metadata management unit 40 may be applied to the metadata management program 86.

As described above, in the present embodiment, since whether to output both the image data and the metadata to the DMS server 10 at the time of process performed in the MFP 2 or to output only the metadata can be controlled, whether or not to output the image data can be determined based on a type of the process. For example, it is usually not necessary to store the image data in the copying process, and only the image data of important documents is stored.

Whether or not to output the image data file can be set with respect to each template of the metadata file, which is prepared in advance in accordance with each type of the processes and target documents. Therefore, the user can easily select whether to output only the metadata or to output both the image data and the metadata.

Whether or not to output the image data file may be set in advance in the apparatus with respect to each type of the processes. Alternatively, a switch used to select whether or not to output the image data may be provided so that the user can select with respect to each process.

The DMS server 10 does not store unnecessary data such as the image data of miscellaneous materials, for example, and stores both the image data and the metadata of the important documents such as contracts, which thereby effectively uses the memory.

Further, the administrator can manage the usage status of the MFP 2, and can acquire the history (record) of the processes. Since the metadata can be searched via the DMS server 10, the history regarding which user used the MFP 2 and which process was performed can be acquired. Thus, the user can be appropriately and reliably charged for the copying operation, for example. Furthermore, the user, the process, and the handled document, or the like, can be specified, which thereby enables security-oriented document management. Moreover, the purchase order and the invoice etc. can be easily managed or searched, and the image data thereof can be shared.

While the present invention has been described with respect to embodiments thereof, it will be apparent to those skilled in the art that the disclosed invention may be modified in numerous ways and may assume many embodiments other than those specifically set out and described above. Accordingly, the appended claims are intended to cover all modifications of the present invention that fall within the true spirit and scope of the present invention.

What is claimed is:

1. An image processing apparatus having a scanner and a printer comprising:
an image data and a metadata in which an attribute of the image data is described are transmitted to a document management server; and
an output control unit is provided to control whether to output both the image data and the metadata together or to output only the metadata.

2. The image processing apparatus according to claim 1, further comprising a storage unit arranged to store a plurality of templates of the metadata, wherein
the output control unit controls in accordance with a type of the template.

3. The image processing apparatus according to claim 1, wherein a switch is provided to allow a user to select whether or not to output only the metadata.

4. The image processing apparatus according to claim 1, wherein the metadata that is used for a copying process includes at least information that is used to specify a user and a number of printouts.

5. The image processing apparatus according to claim 2, wherein the metadata that is used for a copying process includes at least information that is used to specify a user and a number of printouts.

6. The image processing apparatus according to claim 3, wherein the metadata that is used for a copying process includes at least information that is used to specify the user and a number of printouts.

7. A computer readable medium characterized in that:
the computer readable medium contains a program of an image processing apparatus having a scanner and a printer, said program when executed implements:
transmiting an image data and a metadata in which an attribute of the image data is described to a document management server, wherein
an output control instruction is executed to control whether to output both the image data and the metadata or to output only the metadata.
